(19) United States
(12) Patent Application Publication
(10) Pub. No.: US 2006/0128877 A1
(43) Pub. Date: Jun. 15, 2006

(54) High-molecular weight compounds with regulatable hydrophilic-hydrophobic balance, and method of producing the same

(76) Inventors: Tim Goldburt, Chappaqua, NY (US); Gennadiy Leplyanin, Ardsley, NY (US)

Correspondence Address: Ilya Zborovsky, 6 Schoolhouse Way, Dix Hills, NY, 11746, US

(21) Appl. No.: 11/011,340

(22) Filed: Dec. 14, 2004

(51) Int. Cl. C08L 33/00

(52) U.S. Cl. 524/556; 526/317.1

(57) ABSTRACT

A copolymer has a plurality of links each including a derivative of acrylic acid and a beta-finial acrylic acid, with a same sequence of acrylic acid and β-phenylacrylic acrylic acid in all links, wherein derivatives of the acids are amides of the acids and ammonium salts of the acids.

### BACKGROUND OF THE INVENTION

The present invention relates to a chemistry of high molecular weight compounds, in particular to methods of manufacturing water-soluble polymers with a regulatable hydrophilic-hydrophobic balance.

Such polymers, both natural and synthetic, are used for producing gel systems, which are used in different areas of technologies. The main difference of the natural polymers is the regularity of makeup of the main chain of macromolecule and distribution of hydrophilic groups along it. During a synthesis of synthetic polymers by means of polymerization, due to a statistic nature of joining of monomer molecules to a chain (head-tail, head-head, tail-tail), regular structures are not produced.

### SUMMARY OF THE INVENTION

Accordingly, it is an object of the present invention to provide a method of producing a copolymer which eliminates the disadvantages of the prior art, as well as to provide a copolymer produced by the inventive method.

In keeping with these objects and with others which will become apparent hereinafter, one feature of the present invention resides, briefly stated, in a copolymer, comprising a plurality of links each including a derivative of acrylic acid and β-phenylacrylic acid, with a same sequence of the acrylic acid and the β-phenylacrylic acid in all links, wherein the derivatives of said acids are amides of said acids and ammonium salts of said acids.

Another feature of the present invention resides, briefly stated, in a method of producing a copolymer, comprising the steps of obtaining a copolymer with a plurality of links each including a derivative of acrylic acid and a β-phenylacrylic acid, with a same sequence of acrylic acid and β-phenylacrylic acid in all links, wherein the derivatives of said acids are amides of said acids and ammonium salts of said acids.

The novel features which are considered as characteristic for the present invention are set forth in particular in the appended claims. The invention itself, however, both as to its structure and its method of operation, together with additional objects and advantages thereof, will be best understood from the following description of specific embodiments.

### DESCRIPTION OF THE PREFERRED EMBODIMENTS

In accordance with the present invention a copolymer is produced, which has a regular makeup of a main chain of a macromolecule.

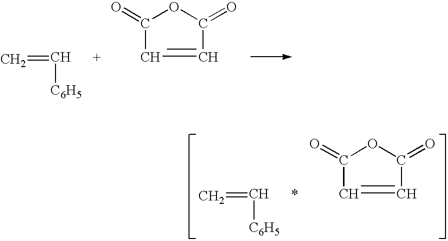

In accordance with the present invention first styrene is mixed with maleic anhydride as shown herein above. Thereafter, the mixture is subjected to a radical polymerization in the presence of ammonium. As a result, a copolymer chain with alternating links is produced as shown herein below.

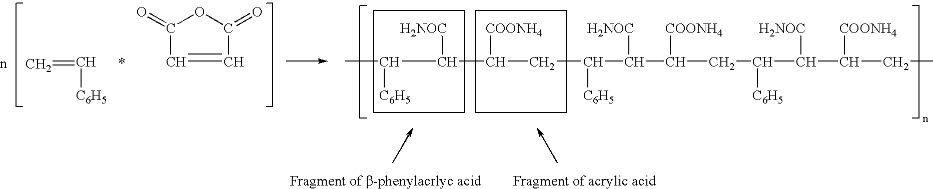

In the thusly obtained copolymer chain each link contains a derivative of β-phenylacrlyc acid and acrylic acid. The sequence of the derivatives of these two acids in each link of the chain remains the same.

As the derivatives of the acids, amides and ammonium salts of the acrylic acid and of the β-phenylacrylic acid are utilized. While the nature of the derivatives can be arbitrary, in all the links of the chain the sequence of the derivatives of the certain acid is the same, namely first a derivative of β-phenylacrylic acid and a derivative of acrylic acid and vice versa. As a result the main chain of the macromolecule has a regular makeup. Opening of the anhydride links of the maleic anhydride by ammonium transforms a copolymer of styrene with maleic anhydride into a copolymer of amides and ammonium salts of β-phenyl acrylic and acrylic acids.

All reactions are performed parallel, substantially simultaneously, in a single reactor. The reactions are performed in the presence of conventional initiators of radical polymerization, such as a dibenzoyl peroxide, azoizobytironitryl, dicyclogexyl peroxy dicarbonate, etc.

The above mentioned copolymer can be produced for example in accordance with the following example.

### EXAMPLE

100 g (1.02 mol) of maleic anhydride, 104 g (1.00 mol) of freshly prepared styrene, 1.0 g (0.0041 mol) of dibenzyol peroxide in 1. L benzol are introduced into a vessel provided with a mixer, a reflux condenser and a gas supply pipe. Maleic anhydride is dissolved in benzol, and thereafter the mixture is heated with continuous mixing in a water bath at a temperature of 40° C.-50° C. during 6-7 hours with a simultaneous supply of ammonium. Probes are periodically taken of the suspension thusly produced. A settled product is filtered, washed by benzol, and dried in a vacuum at the temperature of 60° C. Completeness of reaction is determined by stopping of accumulation of a solid phase.

After the process is finished, the product is cooled to room temperature, the thusly obtained copolymer is filtered, washed out on the filter by benzol, dried in vacuum to a constant weight. As a result 232 G 98% of theoretically quantity of the product is obtained. The specific mass is 0.8-1.0 g/cm³, molecular mass 6-8*10⁵, decomposition temperature 110° C.

The thusly obtained product is a powder. It swells in water so as to form gel. The product dissolves in glycerin and ethanol.

The material in accordance with the present invention can be used for transportation of heavy mineral materials, for example sand as well as heavy organic materials which are not soluble in water, for example viscous oils, naphta, etc. For this purpose, a gel is produced in a manner specified herein above, in particular by mixing the material and swelling in water. Then, the thusly obtained gel is mixed with a material to be transported, and the thusly obtained mixture is conveyed along a conveying structure, for example a pipeline.

The copolymer in accordance with the present invention can be also used for thickening emulsions of organic substances, for example for the purpose of facilitation of their application on surfaces or impregnation of materials. For this purpose the gel is produced as described hereinabove. Thereafter the gel is mixed with a corresponding organic substance to produce an emulsion and the thusly obtained emulsion is applied on the surface or a corresponding material is impregnated with it. Examples of such organic substances are for example paints, oils, fire-retardant substances, etc.

The inventive material can be used for enhancing the growth of seeds. For this purpose the gel is produced as specified above. Then, the gel is mixed with water and with a material which enhances growth of the seeds, and the seeds are covered before sowing with the thusly obtained material.

The inventive material can be used for preventing unauthorized falling of seeds. For this purpose the gel is produced as specified above. Then water is added, and the thusly obtained product is sprayed on the seeds.

The inventive material can be also used for application of pesticides, repellants, etc. on a crop. For this purpose the copolymer is mixed with and swollen in water. A powder component of a pesticide, a repellent, etc., is added so as to obtain a paste. The paste is dispersed in water so as to produce an emulsion. The thusly obtained emulsion on a crop is applied.

The inventive material can be used for producing medical, perfumery, or cosmetic substances. For this purpose the copolymer is mixed with and swollen in water. A medical, perfumery or cosmetic substance is introduced into the gel, so that the gel forms a base for the corresponding substance.

The inventive material can be used for producing a lubricant or a coolant for machining. For this purpose the copolymer is mixed with and swollen in water. A lubricant a coolant is introduced into the gel, so as to produce the final lubricant and coolant for machining.

The inventive material can be used for producing chemical-mechanical or mechanical substances, for example, abrasives, etc. For this purpose the copolymer is mixed with and swollen in water to form gel. A chemical-mechanical or mechanical substance for machining is introduced into the gel so as to produce the final material for machining.

Aerosols can be produced with the use of the inventive materials. For this purpose, the copolymer is mixed with and swollen in water to form a gel. Then a material for forming an aerosol is introduced into the gel, so as to produce a final aerosol which can be sprayed for corresponding purposes.

It will be understood that each of the elements described above, or two or more together, may also find a useful application in other types of substances and methods differing from the types described above.

While the invention has been illustrated and described as embodied in a high-molecular weight compounds with regulatable hydrophilic-hydrophobic balance, and method of producing the same, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims.

1. A copolymer, comprising a plurality of links each including a derivative of acrylic acid and a beta-finial acrylic acid, with a same sequence of acrylic acid and β-phenylacrylic acrylic acid in all links, wherein derivatives of said acids are amides of said acids and ammonium salts of said acids.

2. A method of producing a copolymer, comprising the steps of producing a copolymer with a plurality of links each including a derivative of acrylic acid and β-phenylacrylic acrylic acid; providing a same sequence of acrylic acid and the β-phenylacrylic acrylic acid in all links; and providing derivatives of said acids as amides of said acids and ammonium salts of said acids.

3. A method as defined in claim 2, wherein said obtaining includes mixing of styrene and maleic anhydride; and conducting a radical polymerization of mixture in presence of ammonia, so as to obtain a plurality of links each including a derivative of an acrylic acid and a β-phenylacrylic acrylic acid, with a same sequence of the acrylic acid and the β-phenylacrylic acrylic acid in all links, wherein the derivatives of said acids are amides of said acids and ammonium salts of said acids.

4. A gel, comprising a copolymer with a plurality of links each including a derivative of acrylic acid and β-phenylacrylic acrylic acid, with a same sequence of acrylic acid and β-phenylacrylic acrylic acid in all links, wherein derivatives of said acids are amides of said acids and ammonium salts of said acids, said copolymer being mixed with and swollen in water.

5. A method of transporting of a material along a conveying structure, comprising the steps of producing the gel as defined in claim 4; mixing a material to be transported with the gel; and transporting the material in mixture with the gel.

6. A method of using emulsions of organic substances for material treatments, comprising the steps of obtaining the gel as defined in claim 4, mixing the gel with an emulsion of an organic substance; and using a thusly obtained material for applying on a surface or impregnating another material.

7. A method of coating seeds of grains and vegetables, comprising the steps of preparing the gel as defined in claim 4; mixing the gel with water and with a material which enhances growth of the seeds; and covering the seeds before sowing with a thusly obtained material.

8. A method of preventing unintended falling of seeds of grass cultures, vegetable cultures, etc., comprising the steps of preparing the gel as defined in claim 4; adding water; and spraying a thusly obtained product on seeds.

9. A method of producing crop treatment materials, such as pesticides, repellants, etc., comprising the steps of preparing the gel as defined in claim 4, derivative of an acrylic acid and a beta-finial acrylic acid, with a same sequence of the acrylic acid and the beta-finial acrylic acid in all links, wherein the derivatives of said acids are amides of said acids and swollen in water; adding a powder component of a pesticide, a repellent, etc. to the gel, so as to obtain a paste; dispersing the paste in water so as to produce an emulsion; and applying a thusly obtained emulsion on a crop.

10. A method of producing an ointment composition selected from the group consisting of a medical ointment composition, a perfumery ointment composition and a cosmetic ointment composition, comprising the steps of preparing a gel as defined in claim 4; and introducing into the gel a composition selected from the group consisting of medical, perfumery and cosmetic substance, so that said gel forms a base for the substance.

11. A method of producing a lubricant or a coolant for machining, comprising the steps of producing a gel as defined in claim 4; and introducing in the gel a lubricant or a coolant, so as to produce a final lubricant and cooling and machining.

12. A method of producing a machining composition, such as for chemical-mechanical polishing, mechanical polishing, etc., comprising the steps of producing a gel as defined in claim 4; and introducing a chemical-mechanical or mechanical substance for machining into the gel, so as to produce a final material for machining.

13. A method of producing a high stability aerosol, comprising the steps of producing a gel, as defined in claim 4; and introducing into the gel a material for forming an aerosol, so as to produce a final aerosol which can be sprayed for corresponding purposes.
